(19) United States
(12) Patent Application Publication
(10) Pub. No.: US 2011/0044695 A1
(43) Pub. Date: Feb. 24, 2011

(54) Visible Light Communication System

(76) Inventors: Tae-Jong Jun, Suwon-si (KR); Jongseo Lee, Hwaseong-si (KR); Soo-Lin Kim, Seoul (KR); Jooyoung Lee, Seoul (KR); Jung-Suk Han, Hwaseong-si (KR)

Correspondence Address: F. CHAU & ASSOCIATES, LLC, 130 WOODBURY ROAD, WOODBURY, NY, 11797, US

(21) Appl. No.: 12/714,675

(22) Filed: Mar. 1, 2010

(30) Foreign Application Priority Data
Aug. 24, 2009 (KR) 10-2009-0078197

(51) Int. Cl. H04B 10/00

(52) U.S. Cl. 398/130

(57) ABSTRACT

A visible light communication system includes a light source emitting a first light having information, an optical filter receiving the first light and an externally provided second light and filtering the first and second light according to wavelength bands of the first and second light to output a filtered light, a photoelectric device receiving the filtered light to generate an output signal, and a data output part receiving the output signal to output data. Accordingly, the external light not having information may be substantially prevented from being provided to the photoelectric device, thereby preventing noise from occurring on the output signal. In addition, no additional operation is required to filter the output signal from the photoelectric device.

### CROSS-REFERENCE TO RELATED APPLICATION

This application claims priority from Korean Patent Application No. 10-2009-0078197 filed on Aug. 24, 2009, the contents of which are herein incorporated by reference in their entirety.

### BACKGROUND

1. Field of the Invention

The present disclosure is directed to a visible light communication system. More particularly, the present invention relates to a visible light communication system capable of improving communication quality.

2. Description of the Related Art

Visible light communication is a wireless light communication using visible light. Accordingly, when using visible light communication, wireless communication may be realized by using light generated by illumination devices or display devices.

For instance, in a display device employing a light emitting diode as its light source, users do not perceive a the device refresh frequency of about 100 Hz. However, if the light emitted from the light source is modulated to incorporate information, the modulated light may be used for light communication as the modulated light is used to display an image through the display device.

### SUMMARY

Exemplary embodiments of the present invention provide a visible light communication system capable of reducing noise and improving communication quality.

According to an exemplary embodiment of the present invention, a visible light communication system includes a light source that emits a first light having information, an optical filter that receives the first light and an externally provided second light and filters the first and second lights according to wavelength ranges of the first and second lights to output a filtered light, a photoelectric device that receives the filtered light to generate an output signal, and a data output part that receives the output signal to output data.

According to another exemplary embodiment of the present invention, a visible light communication system includes a display apparatus that generates a first light having information to display an image, and a data output apparatus that received the first light and generates an output signal having data corresponding to the information of the first light.

The data output apparatus includes an optical filter that receives the first light and an externally provided second light and filters the first and second light according to a wavelength bands of the first and second light to output a filtered light, and a photoelectric device that receives the filtered light to generate the output signal.

According to the above, the data output apparatus includes the optical filter and the photoelectric device, and the optical filter filters the first and second light provided to the photoelectric device. Thus, external light not having information may be substantially prevented from being provided to the photoelectric device, thereby preventing noise caused by the external light from occurring in the output signal. In addition, no additional operation is required to filter the output signal from the photoelectric device.

### BRIEF DESCRIPTION OF THE DRAWINGS

FIG. 1 is a block diagram showing a configuration of a visible light communication system according to an exemplary embodiment of the present invention.

FIG. 2 is a view showing a visible light communication system of FIG. 1.

FIGS. 3A to 3C are views each showing a configuration of a light emitting diode of alight source of FIG. 1.

FIG. 4 is a view showing a light receiving part of a data processing device of FIG. 2.

FIG. 5 is a graph showing a result of filtering an externally provided light using an optical filter of FIG. 4.

FIG. 6 is a graph showing a result of filtering an externally provided light using an optical filter according to another exemplary embodiment of the present invention.

FIG. 7 is a graph showing a result of filtering an externally provided light using an optical filter according to another exemplary embodiment of the present invention.

FIGS. 8A and 8B are views showing a light receiving part according to another exemplary embodiment of the present invention.

### DETAILED DESCRIPTION OF EXEMPLARY EMBODIMENTS

It will be understood that when an element or layer is referred to as being “on”, “connected to” or “coupled to” another element or layer, it can be directly on, connected or coupled to the other element or layer or intervening elements or layers may be present. Like numbers refer to like elements throughout.

Hereinafter, embodiments of the present invention will be explained in detail with reference to the accompanying drawings.

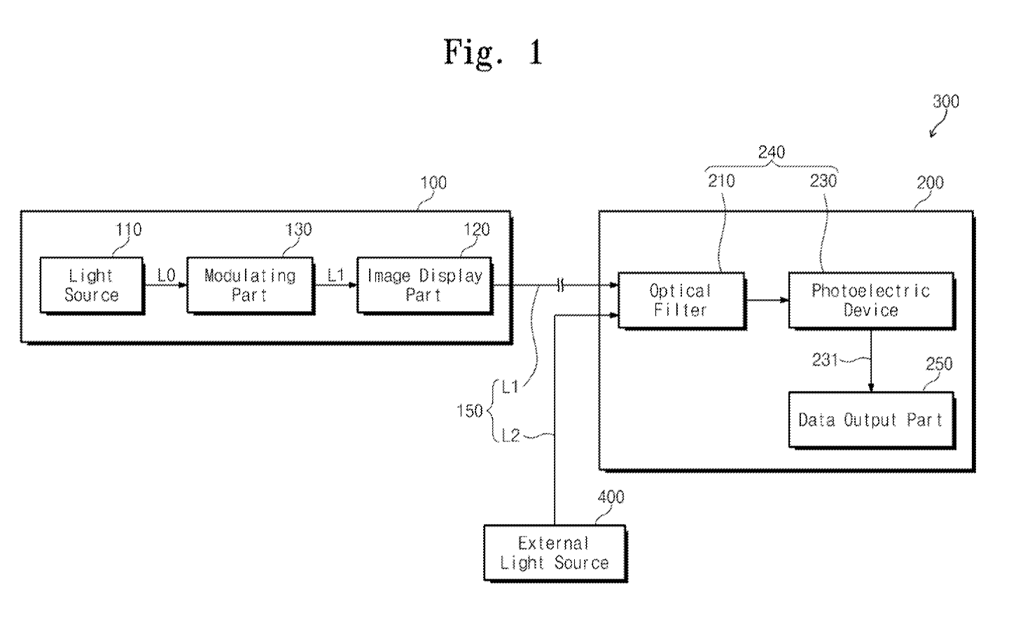

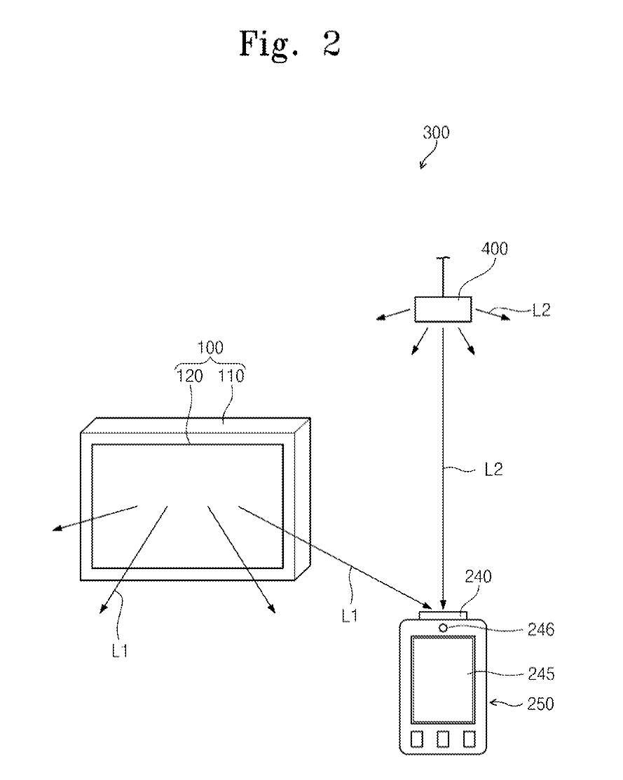

FIG. 1 is a block diagram showing a configuration of a visible light communication system according to an exemplary embodiment of the present invention, and FIG. 2 is a view showing a visible light communication system of FIG. 1.

Referring to FIGS. 1 and 2, a visible light communication system 300 includes a light transmitting apparatus 100 and a light receiving apparatus 200.

The light transmitting apparatus 100 includes a light source 110, an image display part 120, and a modulating part 130. The light source 110 emits a source light L0 used for light communication performed by the visible light communication system 300. In the present exemplary, non-limiting embodiment, the light source 110 may include a plurality of light emitting diodes, but it should not be limited thereto.

The modulating part 130 receives the source light L0 from the light source 110 and modulates the source light L0 to a first light L1 having information. In this case, the source light L0 is modulated by the modulating part 130 to have a high frequency higher than 100 Hz. As a result, the first light L1 may be used to display an image since a user does not perceive flickering of the first light L1. Accordingly, the first light L1 may be provided to the image display part 120, and the image display part 120 may display the image using the first light L1.

According to an embodiment of the invention, the light transmitting apparatus 100 may be a liquid crystal display that displays the image and simultaneously provides light having information to the light receiving apparatus 100. If the light transmitting apparatus 100 is the liquid crystal display, the light source 110 may be a backlight assembly for the liquid crystal display and the image display part 120 may be a liquid crystal display panel for the liquid crystal display.

Alternatively, the light transmitting apparatus 100 may be an organic light=emitting type display apparatus that is a self-emissive display apparatus. In case of employing an organic light-emitting type display apparatus as the light transmitting apparatus 100, the image display part 120 may be a display panel including organic light-emitting diodes, and the light source 110 may be removed from the light transmitting apparatus 100 since an organic light-emitting type display apparatus is a self-emissive display apparatus.

The light receiving apparatus 200 includes a light receiving part 240 and a data output part 250. The light receiving part 240 includes an optical filter 210 and a photoelectric device 230. The optical filter 210 receives the first light L1 and a second light L2 emitted from an external light source 400, collectively referred to as input light 150, and filters the first and second lights L1 and L2 according to wavelengths of the first and second lights L1 and L2. The photoelectric device 230 serves as a device that converts light energy into electrical energy as well as a phototransistor and a photodiode, and thus the photoelectric device 230 receives the filtered light from the optical filter 210 and outputs an output signal 231.

In detail, the optical filter 210 selectively filters light having the specific wavelengths of the first and second lights L1 and L2. Accordingly, the intensity of the light provided to the photoelectric device 230 after being filtered by the optical filter 210 is less than the sum of the intensity of the first light L1 and the intensity of the second light L2. However, since the optical filter 210 filters the second light L2 more than the first light L1, the intensity reduction of the second light L2 is greater than that of the first light L1.

Thus, due to the filtering of the optical filter 210, the intensity of the first light L1 provided to the photoelectric device 230 may be greater than the intensity of the second light L2 provided to the photoelectric device 230, thereby reducing noise in the output signal 231 from the photoelectric device 230 caused by the second light L2.

That is, the filtering of the optical filter 210 with respect to the input light 150 is to reduce or eliminate the intensity of the second light L2 being provided to the photoelectric device 230 with respect to the intensity of the first light L1. This is because the first light L1 includes the information needed for the visible light communication and the second light L2 does not include the information. Moreover, the noise may occur in the visible light communication due the second light L2.

The data output part 250 receives the output signal 231 from the photoelectric device 230 and outputs data. Referring to FIG. 2, according to an embodiment of the invention, the data output part 231 may include an image display device 245 that displays an image using the output signal 231 from the photoelectric device 230, but it should not be limited thereto. That is, the data output part 250 may further include a speaker 246 that outputs sounds according to the output signal 231, or the data output part 250 may further include a processor that stores information included in the output signal 231 into a storage device.

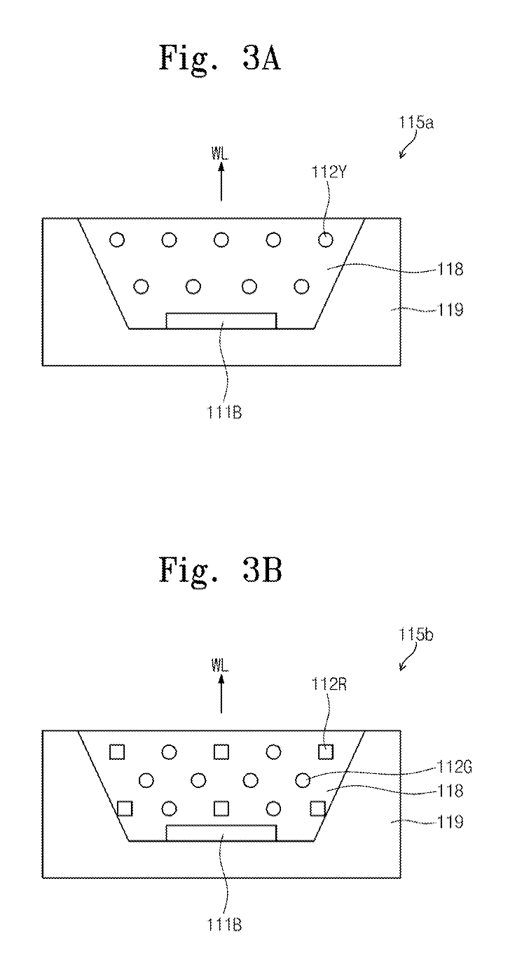

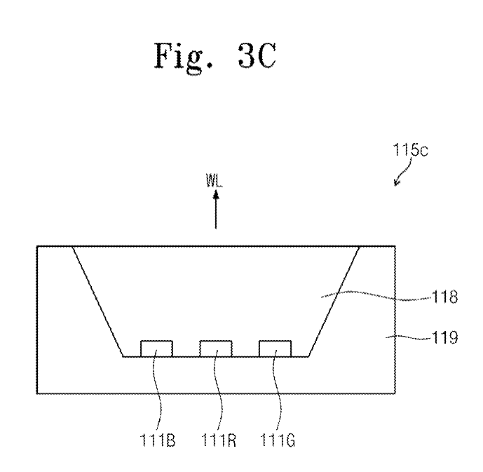

FIGS. 3A to 3C are views each showing a configuration of a light emitting diode of alight source of FIG. 1.

Referring to FIG. 3A, the light source 110 shown in FIG. 2 includes a first light emitting diode 115a. The first light emitting diode 115a includes a container 119, a blue light emitting diode 111B arranged in the container 119, a molding member 118 filled in the container 119 to protect the blue light emitting diode 111B, and a yellow fluorescent substance 112Y dispersed in the molding member 118.

The blue light emitting diode 111B emits a blue light, and the yellow fluorescent substance 112Y includes a fluorescent material such as Yttrium Aluminum Garnet (YAG). Accordingly, the blue light emitted from the blue light emitting diode 111B is mixed with a light emitted from the yellow fluorescent substance 112Y, so that the first light emitting diode 115a may emit white light WL.

Referring to FIG. 3B, the light source 110 shown in FIG. 2 may include a second light emitting diode 115b instead of the first light emitting diode 115a. The second light emitting diode 115b includes a blue light emitting diode 111B, a red fluorescent substance 112R, and a green fluorescent substance 112G. Thus, the blue light emitted from the blue light emitting diode 111B is mixed with the light emitted from each of the red and green fluorescent substances 112R and 112G, and thus the second light emitting diode 115b may emit white light WL.

Referring to FIG. 3C, the light source 110 shown in FIG. 2 may include a third light emitting diode 115c instead of the first and second light emitting diodes 115a and 115b. The third light emitting diode 115c includes a blue light emitting diode 111B emitting a blue light, a red light emitting diode 111R emitting a red light, a green light emitting diode 111G emitting a green light. As a result, the blue, the red light, and the green light are mixed with each other, so the third light emitting diode 115c may emit white light WL.

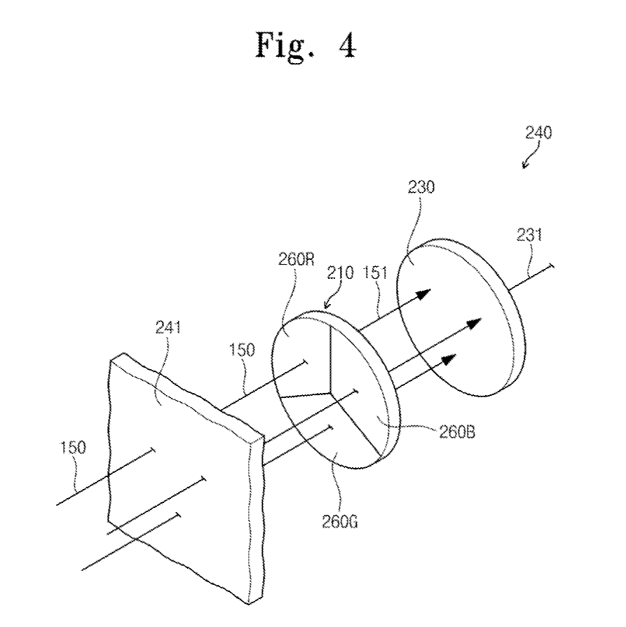

FIG. 4 is a view showing a light receiving part of a data processing device of FIG. 2.

Referring to FIG. 4, the light receiving part 240 includes a case 241, the optical filter 210, and the photoelectric device 230.

The case 241 includes a transparent material that transmits light therethrough. The case 241 receives the optical filter 210 and the photoelectric device 230 therein and protects the optical filter 210 and the photoelectric device 230 from external impacts.

The optical filter 210 includes a plurality of filters that each selectively filter different wavelengths of lights. Particularly, the optical filter 210 includes a first filter 260B that selectively transmits light having a first wavelength range, a second filter 260G that selectively transmits light having a second wavelength range different from the first wavelength range, and a third filter 260R that selectively transmits light having a third wavelength range different from the first and second wavelength ranges.

The filtering operation of the optical filter 210 with respect to the light provided to the photoelectric device 230 is as follows. An input light 150 is provided to the first to third filters 260R, 260G, and 260B of the optical filter 210 after passing through the case 241.

Referring to FIGS. 2 and 4, the input light 150 includes the first light L1 output from the light transmitting apparatus 100 and the second light L2 output from the external light source 400. According to an embodiment of the invention, first light L1 having information may be provided to the light receiving part 240, but the second light L2 output from the external light source 400, such as a fluorescent lamp, may also be provided to the light receiving part 240 with the first light L1 as part of a user's surroundings.

The input light 150 is provided to the first to third filters 260B, 2606, and 260R, and the first to third filters 260B, 260G, and 260R selectively transmit the input light 150 according to the wavelength range of the input light 150.

For example, if the second light L2 has a higher intensity in a fourth wavelength range and a fifth wavelength range, the optical filter 210 may be designed to block light having the fourth and fifth wavelength ranges. More particularly, since the first to third filters 260B, 260G, and 260R respectively transmit light having the first to third wavelength ranges and the first to third wavelength ranges are different from each other, the first to third filters 260B, 260G, and 260R may be designed such that the fourth wavelength range is in between the first wavelength range and the second wavelength range and the fifth wavelength range is in between the second wavelength range and the third wavelength range. As a result, the optical filter 210 may transmit light having the first, second and third wavelength ranges and block light having the fourth and fifth wavelength ranges.

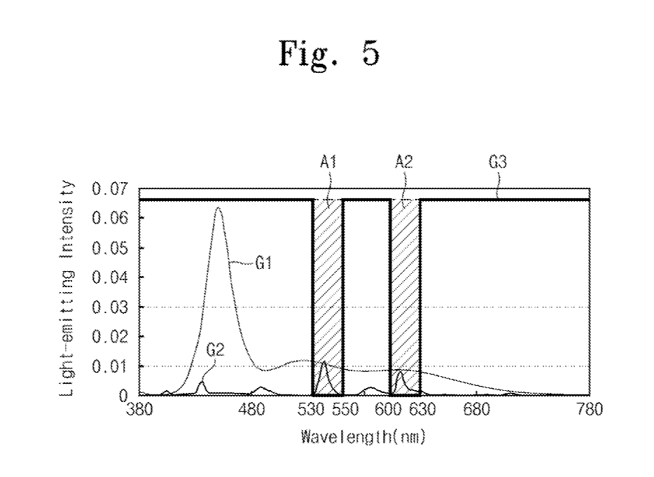

The external light source 400 may be a fluorescent lamp, but it should not be limited thereto. In general, light emitted from a fluorescent lamp may have a higher intensity in a wavelength range from about 530 nanometers to about 550 nanometers and in a wavelength range from about 600 nanometers to about 630 nanometers than that of the light in other wavelength ranges. Accordingly, among light emitted from the fluorescent lamp, the optical filter 210 may be designed to block light having a wavelength of about 530 nanometers to about 550 nanometers or light having a wavelength of about 600 nanometers to about 630 nanometers. Detailed descriptions of the optical filter will be described with reference to FIGS. 5 to 7.

Meanwhile, the input light 150 filtered by the optical filter 210 becomes a filtered light 151, and the filtered light 151 is provided to the photoelectric device 230. The photoelectric device 230 is disposed in the light receiving part 240 to face the optical filter 210. The photoelectric device 230 receives the filtered light 151 from the optical filter 230 and outputs the output signal 231 corresponding to the filtered light 151. The output signal 231 is provided to the data output part 250 shown in FIG. 1, and the data output part 250 outputs the data corresponding to the output signal 231 from the photoelectric device 230.

FIG. 5 is a graph showing a result of filtering an externally provided light using an optical filter of FIG. 4.

Referring to FIGS. 2 and 5, if the light source 110 of the light transmitting apparatus 100 includes a first light emitting diode 115a shown in FIG. 3A and the external light source 400 is a fluorescent lamp, a first graph G1 represents a light-emitting intensity of the first light L1 shown in FIG. 2 as a function of the wavelength of the first light L1, and a second graph G2 represents a light-emitting intensity of the second light L2 shown in FIG. 2 as a function of the wavelength of the second light L2. In FIG. 5, the light-emitting intensity is indicated in arbitrary unit (A.U.).

In addition, a third graph G3 represents a degree by which light is filtered by the optical filter 210 shown in FIG. 4, as a function of wavelength. A first light blocking band A1 and a second light blocking band A2 of the third graph G3 represent wavelength ranges in which the light is blocked by the optical filter 210.

Referring to the first graph G1, the first light L1 has a relatively high light intensity in a range from about 400 nanometers to about 480 nanometers. Referring to the second graph G2, the second light L2 has a relatively high light intensity in the range from about 530 nanometers to about 550 nanometers and the range from about 600 nanometers to about 630 nanometers. Accordingly, to effectively block the second light L2 provided to the photoelectric device 230 by using the optical filter 210, the optical filter 210 may be designed as follows.

That is, the optical filter 210 may be designed such that the first filter 260B transmits light having a wavelength of about 380 nanometers to about 530 nanometers, the second filter 260G transmits light having a wavelength of about 550 nanometers to about 600 nanometers, and the third filter 260R transmits light having a wavelength of about 630 nanometers to about 780 nanometers. As a result, the optical filter 210 may block light having a wavelength of about 530 nanometers to about 550 nanometers corresponding to the first light blocking band A1 and light having a wavelength of about 600 nanometers to about 630 nanometers corresponding to the second light blocking band A2. Thus, the intensity of the second light L2 of the input light 150 may be reduced by the optical filter 210, thereby increasing the intensity of the first light L1 in the filtered light 151.

In addition, the external light source 400 shown in FIG. 2 may be a light source other than a fluorescent lamp. For instance, suppose the external light source 400 includes the third light emitting diode 115c shown in FIG. 3C, which emits light having higher intensity in a range from about 480 nanometers to about 530 nanometers and in a range from about 550 nanometers to about 650 nanometers. In this case, the optical filter 210 may be designed to allow the first filter 260B to transmit light having a wavelength of about 380 nanometers to about 480 nanometers, the second filter 260G to transmit light having a wavelength of about 530 nanometers to about 550 nanometers, and the third filter 260R to transmit light having a wavelength of about 650 nanometers to about 780 nanometers. Accordingly, the optical filter 210 may block light having a wavelength of about 480 nanometers to about 530 nanometers and light having a wavelength of about 550 nanometers to about 650 nanometers, to thereby increase the intensity of the first light L1 in the filtering light 151 relative to the light emitted from the third light emitting diode.

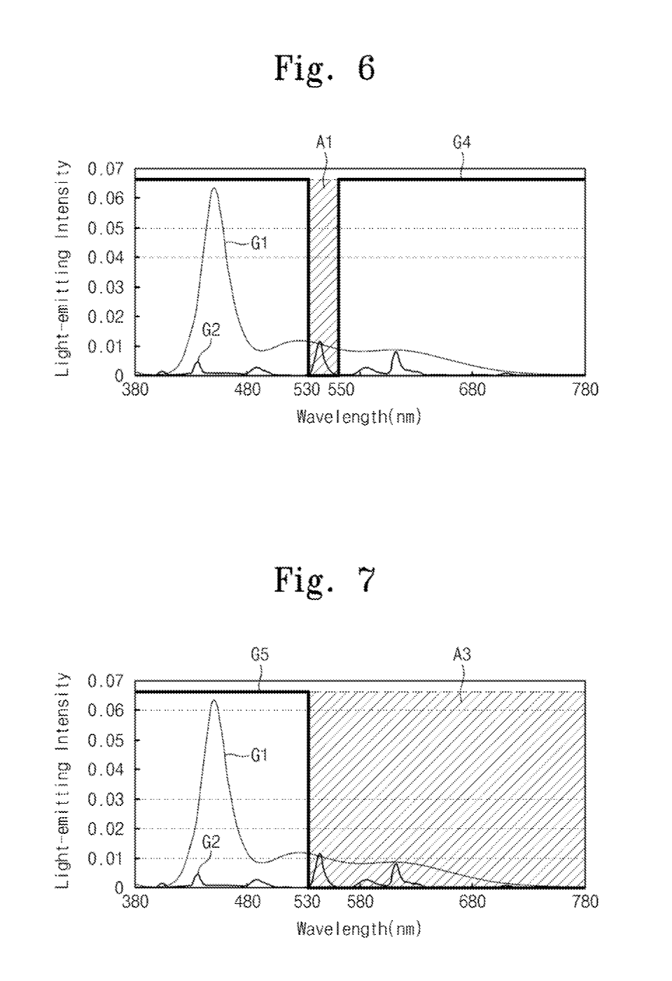

FIG. 6 is a graph showing a result of filtering an externally provided light using an optical filter according to another exemplary embodiment of the present invention.

Referring to FIG. 6, an optical filter (not shown) according to another exemplary embodiment may include two filters that selectively transmit light having different wavelength ranges. In detail, one of the two filters transmits light having a wavelength of about 380 nanometers to about 530 nanometers, and the other of the two filters transmits light having a wavelength of about 550 nanometers to about 780 nanometers.

A fourth graph G4 represents a degree by which light is filtered by the optical filter, and a first light blocking band Al of the fourth graph G4 represents those wavelength ranges in which light is blocked by the optical filter. Referring to the fourth graph G4, the optical filter may block light having a wavelength of about 530 nanometers to about 550 nanometers corresponding to the first light blocking band A1. Thus, when the input light 150 provided to the photoelectric device 230 shown in FIG. 4 is filtered by the optical filter, light having a wavelength of about 530 nanometers to about 550 nanometers in the second light may be blocked.

FIG. 7 is a graph showing a result of filtering an externally provided light using an optical filter according to another exemplary embodiment of the present invention.

Referring to FIG. 7, an optical filter (not shown) according to another exemplary embodiment selectively transmits light having the wavelength of about 380 nanometers to about 530 nanometers.

A fifth graph G5 represents a degree to which light is filtered by the optical filter, and a third light blocking band A3 of the fifth graph G5 represent wavelength ranges in which light is blocked by the optical filter. Referring to the fifth graph G5, the optical filter may block light having a wavelength of about 530 nanometers to about 780 nanometers corresponding to the third light blocking band A3. Thus, when the input light 150 provided to the photoelectric device 230 shown in FIG. 4 is filtered by the optical filter, light having a wavelength of about 530 nanometers to about 780 nanometers in the second light may be blocked.

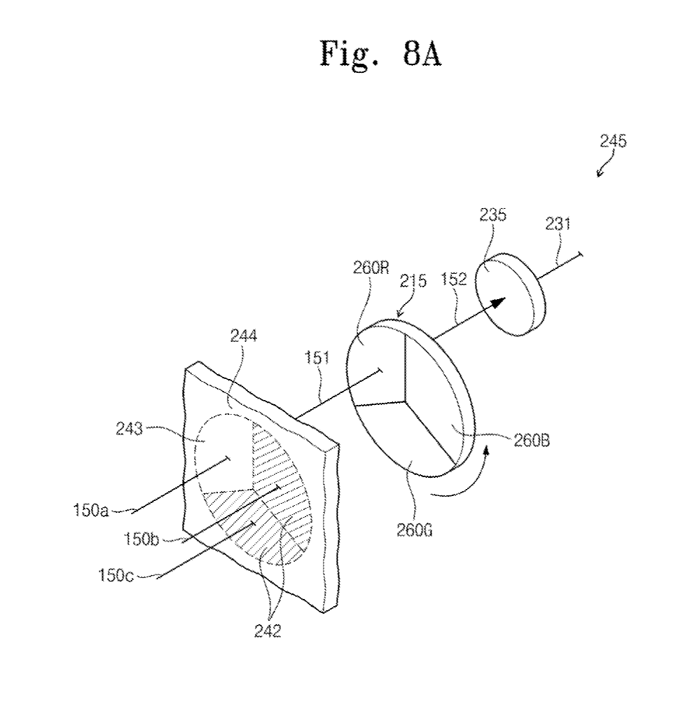

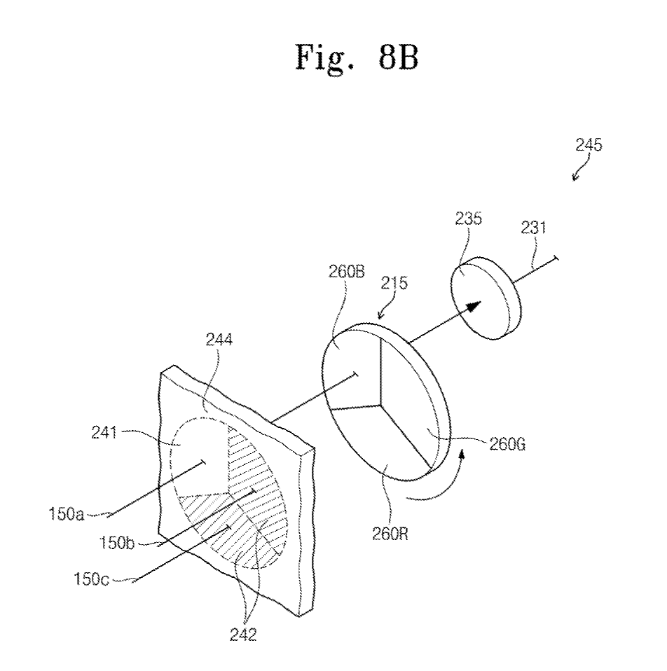

FIGS. 8A and 8B are views showing a light receiving part according to another exemplary embodiment of the present invention. In FIGS. 8A and 8B, the same reference numerals denote the same elements as in FIG. 4, and thus detailed descriptions of the same elements will be omitted.

Referring to FIG. 8A, a light receiving part 245 includes a case 244, an optical filter 215, and a photoelectric device 235. Different from the case 241 shown in FIG. 4, the case 244 includes a light transmitting portion 243 through which light is transmitted and a light blocking portion 242 through which light is not transmitted. The optical filter 215 may be rotated with respect to a rotation axis substantially parallel to a direction in which first, second, and third input light 150a, 150b, and 150c travel.

Accordingly, when the first to third input light 150a, 150b, and 150c are provided to the light receiving part 245, the first input light 150a is provided to the optical filter 215 through the light transmitting portion 243.

The optical filter 215 may be rotated according to the wavelengths of the first to third input light 150a, 150b, and 150c. In particular, if the third filter 260R selectively transmits light having a wavelength of about 630 nanometers to about 780 nanometers and the first and third input light 150a, 150b, and 150c have a wavelength of about 630 nanometers to about 780 nanometers corresponding to red light, the optical filter 215 may rotate such that the third filter 260R faces the light transmitting portion 243. As a result, the first input light 150a transmitted through the case 244 may be provided to the photoelectric device 235 after being transmitted through the third filter 260R.

As described above, the optical filter 215 rotates according to which of the wavelengths of the first to third input light 150a, 150b, and 150c are to be transmitted, since the wavelength of the first light L1 emitted from the light transmitting apparatus 100 shown in FIG. 2 is not limited to specific wavelength ranges. For example, the light transmitting apparatus 100 may transmit red light for a duration of time. If the light receiving part 240 shown in FIG. 4 includes the optical filter 210 shown in FIG. 4, the intensity of the light provided to the photoelectric device 230 shown in FIG. 4 through the optical filter 210 is relatively decreased since only red light is transmitted through the third filter 260R of the optical filter 210.

However, as described above with reference to FIG. 8A, when the orientation of the optical filter 215 varies according to colors of the first to third input light 150a, 150b, and 150c that are externally provided, the optical filter 215 may filter the second light L2 shown in FIG. 2 and simultaneously reduce the loss of the input light provided to the photoelectric device 230 through the optical filter 215.

Referring to FIG. 8B, in a case that the first to third input light 150a, 150b, and 150c have a wavelength of about 380 nanometers to about 530 nanometers corresponding to blue light, the optical filter 215 may rotate to allow the first filter 260B to face the light transmitting portion 243. As a result, the first input light 150a transmitted through the case 244 may be provided to the photoelectric device 235 after being transmitted through the first filter 260B. Thus, when the light transmitting apparatus 100 transmits blue light for a duration of time, blue light may be transmitted through the first filter 260B. Therefore, the optical filter 215 may filter the second light L2 shown in FIG. 2 and simultaneously reduce the loss of the input light provided to the photoelectric device 230 through the optical filter 215.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A visible light communication system comprising:
a light source that emits a first light having information;
an optical filter that receives the first light and an externally provided second light and filters the first and second lights according to wavelength bands of the first and second light to output a filtered light;
a photoelectric device that receives the filtered light to generate an output signal; and
a data output part that receives the output signal to output data.

2. The visible light communication system of claim 1, wherein the first light has a first intensity in a first wavelength band, the second light has a second intensity in a second wavelength band different from the first wavelength band, and the optical filter blocks the second light having a wavelength in the second wavelength band.

3. The visible light communication system of claim 2, wherein the optical filter comprises a plurality of filters each filtering the first and second light according to the wavelength bands of the first and second light, the wavelength band of the first light being different from the wavelength band of the second light, wherein the wavelength band of the filtered light differs from the second wavelength band such that the second light in the second wavelength band is blocked by the plurality of filters.

4. The visible light communication system of claim 3, wherein the first light and the second light are substantially simultaneously provided to the plurality of filters.

5. The visible light communication system of claim 3, wherein the first and second light are provided to one filter of the plurality of filters and the one filter transmits the first light in the first wavelength band.

6. The visible light communication system or claim 1, wherein the light source comprises a light emitting diode.

7. A visible light communication system comprising:
a display apparatus that generates a first light having information for displaying an image; and
a data output apparatus that receives the first light and generates an output signal having data corresponding to the information of the first light,
wherein the data output apparatus comprises:
an optical filter that receives the first light and an externally provided second light and filters the first and second light according to wavelength ranges of the first and second light to output a filtered light; and
a photoelectric device that receives the filtered light to generate the output signal.

8. The visible light communication system of claim 7, wherein the first light has a first intensity in a first wavelength range, the second light has a second intensity in a second wavelength range different from the first wavelength range, and the optical filter blocks the second light having a wavelength in the second wavelength range.

9. The visible light communication system of claim 8, wherein the optical filter comprises a plurality of filters each filtering the first and second light according to the wavelength range of the first and second light, the wavelength range of the first light being different from the wavelength of the second light, wherein the wavelength range of the filtered light differs from the second wavelength range such that the second light in the second wavelength range is blocked by the plurality of filters.

10. The visible light communication system of claim 9, wherein the second wavelength range is from about 530 nanometers to about 550 nanometers or from about 600 nanometers to about 630 nanometers.

11. The visible light communication system of claim 9, wherein the first light and the second light are substantially simultaneously provided to the plurality of filters.

12. The visible light communication system of claim 9, wherein the first and second light are provided to one filter of the plurality of filters and the one filter transmits the first light in the first wavelength range.

13. The visible light communication system of claim 7, wherein the data output apparatus outputs image data in the output signal.

14. The visible light communication system of claim 7, wherein the data output apparatus outputs sound data in the output signal.

15. The visible light communication system of claim 7, wherein the display apparatus comprises:
a light source that emits a source light;
a modulating part that modulates the source light to the first light; and
a display panel that receives the first light to display the image.

16. The visible light communication system of claim 15, wherein the light source comprises a light emitting diode.

17. A visible light communication system comprising:
an optical filter that receives a first light having a first intensity in a first wavelength band and a second light has a second intensity in a second wavelength band different from the first wavelength band to output a filtered light, said optical filter comprises a plurality of filters each filtering the first and second light according to the wavelength bands of the first and second light, wherein the wavelength band of the filtered light differs from the second wavelength band such that the second light in the second wavelength band is substantially blocked by the plurality of filters.

18. The visible light communication system of claim 18, further comprising:
a light source that emits a source light;
a modulating part that modulates the source light to the first light, said first light having information provided by the modulating part;
a display apparatus that displays an image from said information is said first light;
a photoelectric device that receives the filtered light to generate an output signal; and
a data output part that receives the output signal to output data.

19. The visible light communication system of claim 17, wherein said first wavelength band comprises a plurality of non-overlapping wavelength sub-bands, and said second wavelength band comprises a plurality of non-overlapping wavelength sub-bands.
